(19) United States
(12) Patent Application Publication
(10) Pub. No.: US 2015/0120316 A1
(43) Pub. Date: Apr. 30, 2015

(54) METHOD AND SYSTEM FOR DETECTING PROBLEM IMAGES AND FOR ASCERTAINING SOLUTION PROPOSALS

(71) Applicant: OMS Software GmbH, Munich (DE)

(72) Inventor: Christian KRAMER, Munich (DE)

(21) Appl. No.: 14/515,909

(22) Filed: Oct. 16, 2014

Related U.S. Application Data
(63) Continuation of application No. PCT/EP2013/058169, filed on Apr. 19, 2013.

(30) Foreign Application Priority Data
Apr. 19, 2012 (DE) 10 2012 103 450.8

(51) Int. Cl. G06F 19/00; G06Q 10/10

(52) U.S. Cl. CPC G06F 19/3443; G06F 19/345; G06Q 10/10
USPC 705/2

(57) ABSTRACT

A method for acquiring problem images and for determining solution proposals in a system comprising at least a server means and a client means is provided, wherein the client means can be coupled to the server means via a communications network, wherein the sever means is coupled to a storage means, in which a number of problem images, a number of parameters, and a number of solutions are stored, wherein at least one parameter and at least one solution are respectively assigned to the problem images, wherein the parameters assigned to a problem image describe the problem image, and by means of the selected parameters, a solution is determined. Further, a corresponding system is provided, which is also adapted to learn new solutions for new or known problem images. Further, program means for a client means are provided, which are adapted to cooperate with the method according to the invention.

### CROSS REFERENCE TO RELATED APPLICATIONS

This application is a continuation under 35 U.S.C. §120 of International Application PCT/EP2013/058169, filed Apr. 19, 2013, which claims priority to German Application 10 2012 103 450.8, filed Apr. 19, 2012, the contents of each of which are incorporated by reference herein.

### FIELD OF THE INVENTION

The invention relates to a method for acquiring problem images and for determining appropriate solutions. Further, the invention relates to a system for acquiring problem images and for determining appropriate solution proposals which is adapted to carry out the method according to the invention.

### BACKGROUND OF THE INVENTION AND PRIOR ART

In prior art, diagnosis systems are known which are based on a computer assisted data base search according to which a user or more may input problems which have been determined in text form whereupon the diagnosis system determines matching diagnoses and appropriate suggestions for a solution.

Such diagnosis systems, however, are relatively unsatisfactory and imprecise, because in the end they are based on analyzing the problem description input in text form and find by means of the result of the analysis corresponding diagnoses. An erroneous or imprecise analysis of the textual problem description which has been input may lead to an incorrect diagnosis which in turn may lead to the system determining wrong or inadequate solutions. Further, the suggestions for solutions thus determined substantially depend on the quality of the problem description input in text form.

A further disadvantage of known systems is that these only may be operated by qualified people, with respect to medical diagnosis systems, for example, by physicians or medics, because comprehensive and exact problem descriptions, for example, descriptions of the symptoms are necessary. Non-qualified staff, therefore, is not or is only insufficiently able to use such a diagnosis system known from prior art in order to, for example, carry out a diagnosis itself, and to search for appropriate solutions.

A further disadvantage of known diagnosis systems is that, as far as the diagnosis system proposes a measure for solving a problem, the success of the measure for future diagnoses and the measures associated therewith are not taken into consideration, because the known diagnosis systems substantially are static systems, according to which a certain problem is assigned to one or more diagnoses, whereby a diagnosis, in turn, is assigned to one or more solution proposals. An adaptation may only be effected by manually furnishing new problems in the diagnosis system concerned, the new or the existing problems are assigned to new or modified solutions, or already assigned solutions are cancelled. The manual adaptation has the substantial disadvantage that potentially successful solutions to certain problems will not be considered, and therefore, are not available as possible solution approaches for certain problems.

### OBJECT OF THE INVENTION

Therefore, it is an object of the present invention to provide solutions according to which the acquisition of problem images is possible in a particularly easy manner and, in particular, by an ordinary person, and by means of which also for very complex problem images adequate solution proposals can be determined. A further object of the invention, therefore, can be seen therein to provide solutions, which enable during selection of one or more solution proposals, to consider the results of solutions already applied or already carried out.

### SOLUTION ACCORDING TO THE INVENTION

This object is solved according to the invention according to the independent claims by a method for acquiring problem images and for determining solution proposals as well as by a system for acquiring problem images and for determining solution proposals which is adapted to carry out the method according to the invention. Preferred embodiments and further developments of the invention are specified in the respective dependent claims.

Accordingly, a method for acquiring problem images and for determining solution proposals in a system is provided comprising at least one server means and at least one client means, wherein the client means may be coupled to the server means via a communications network, wherein the server means is coupled to a storage means, in which a number of solutions is stored, wherein the problem images respectively are assigned to at least one parameter and at least one solution, wherein the parameters assigned to a problem image describe the problem image, and wherein the server means

a) transmits a number of parameters to the client means for selection of a parameter by a user of the client means,
b) receives the selected parameter from the client means,
c) selects from the stored problem images those problem images to which the received parameters are assigned, and selects from the parameters assigned to the selected problem images those parameters, which do not correspond to the parameters which have already been received,
d) transmits the selected parameter for selection to the client means;
e) repeats the steps b) to d) as long as parameters no longer can be selected in the step c), or until the server means receives a termination signal from the client means,
f) determines the solutions assigned to the selected problem images and transmits these as solution proposals to the client means for selection of a solution proposal by the user of the client means, and
g) receives from the client means a message which comprises information about whether the application of the solution proposal selected by the user to the problem image has been successful.

With respect to the problem image, a problem (e.g., a supposed disease) is concerned, which is described or defined by the one or more parameters (e.g., symptoms). A problem image is not a computer graphics or the like.

Because the description of the problem image results from selection of parameters, it is avoided that a user of the system for describing the problem image has to perform textual inputs, which substantially improves the handling of the system and enables substantially more detailed and more exact problem descriptions. In particular, it is avoided that a semantic analysis of a text by which the problem image is described has to be performed, which, as is known, is prone to a certain inaccuracy and which requires a substantial computing time.

The server means in a further step may receive from the client means the solution proposal selected by the user, may store the received solution proposal together with a user ID in the storage means, and may assign the received parameters to the stored solution proposal

The server means may receive from the client means at least one status message, which comprises information on whether or how the parameters change by applying the selected solution proposal.

It is advantageous, if the at least one status message is received in predetermined temporal intervals. Thereby, a changing of the parameter may be documented over time.

The changing of the parameters over time may be stored in the storage means, and may be assigned to the selected solution proposal, whereby based on the change of the parameters over time for a weighting factor is determined for the selected solution proposal, whereby during determining the weighting factor, preferably a weighting factor which has already been assigned to the selected solution proposal is considered. From the change of the parameters over time, the system may determine autonomously, whether the solution proposal suggested from the system is expedient, and may, if needed, propose an alternative solution proposal to the user. By provision of a weighting factor, the “quality” of a solution proposal can be determined for a certain problem image, such that the system may determine for a certain problem increasingly improved solutions over time, and propose these to the users. In this respect, the system is “self-learning.”

In the step f), for the solution proposals to be transmitted to the client means, an order may be determined, which takes the weighting factors of the solution proposals into consideration.

In addition to the parameters selected in step c), further parameters may be selected which are not assigned to the selected problem images, and are transmitted to the client means for selection as optional parameters, in particular, if in the step c), no parameters can be selected any more.

The optional parameters may be selected and transmitted upon request by the client means.

During selection of an optional parameter by the user, a new problem image may be stored in the storage means, and the received parameters may be assigned to the new problem image.

In step f), solutions may be determined, according to which parameters are assigned to corresponding problem images, which at least partially are comprised in received parameters, and may be transmitted to the client means as solution proposals. Thereby, solutions can be proposed, to which only few of the selected parameters are assigned. From the solutions provided in this manner, new concrete problem solutions for new problem images can be created in the further temporal progress.

The status report may additionally comprise further information whether further parameters have been added to the parameters already received, whereby the further parameters are received by the server means.

The further parameters may be assigned to the new problem image.

Alternatively or additionally, a new problem image may be stored in the storage means, and at least the further parameters may be assigned to the new problem image.

The weighting factor assigned to the selected solution proposal may be determined again, whereby information concerning the parameters already received having been augmented by further parameters affect the weighting factor to be newly determined preferably in a negative manner.

Further, also a system for acquiring problem images and for determining solution proposals is provided by the invention, whereby the system comprises at least a server means, which may be coupled to a client means via a communications network, whereby the server means is coupled to a storage means, in which a number of problem images, a number of parameters, and a number of solutions are stored, whereby at least a parameter and at least a solution is respectively assigned to the problem images, whereby the system further comprises
means for selecting a plurality of parameters and for transmitting the parameter to the client means for selection of a parameter by a user of the client means,
means for receiving selected parameters from the client means,
means for selecting problem images on the basis of received selected parameters and for selecting parameters, which are assigned to the selected problem images, and
means for selecting solution proposals, which are assigned to the selected problem images and for transmitting the selected solution proposals to the client means for selection of a solution proposal by a user of the client means.

The server means and the means of the system may be adapted to carry out the method according to the invention.

In a concrete embodiment of the invention, the problem images may comprises disease patterns, whereby the parameters comprise symptoms according to which disease patterns can be described, and whereby the solution proposals comprise therapy proposals for treatment of at least one disease pattern.

Further, program means for a client means, in particular, a data processing means or a mobile terminal, are provided by the invention, which are adapted
to receive parameters from a system for acquiring problem images and for determining solution proposals, and to display them for selection by a user on a display means of the client means,
to transmit the selected parameters to the system, and
in response to the parameters transmitted to the system, to select further parameters or at least to receive a solution proposal to be selected.

The program means may further be adapted to prompt the user according to predetermined time intervals or according to predetermined points of time, to acquire a change of the parameters and to transmit the acquired changes in a status report to the system.

### BRIEF DESCRIPTION OF THE FIGURES

Further details and features of the invention can be derived from the following description in connection with the drawing, in which

FIG. 1 shows a system for acquiring problem images and for determining solution proposals with a number of client means, which are coupleable to a server means via a communications network according to the invention;

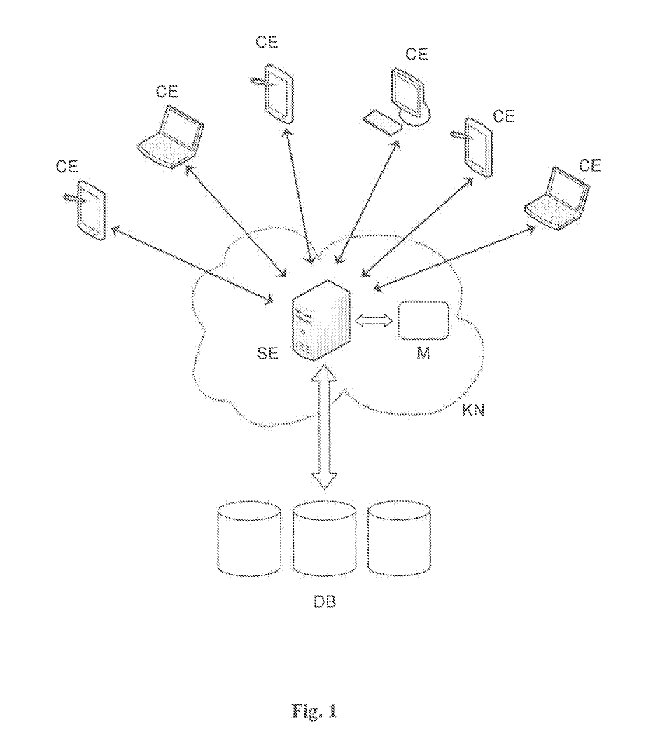

FIG. 2 shows a flow chart of a method for acquiring problem images and for determining solution proposals according to the invention;

FIG. 3 shows a concrete example for determining solution proposals; and

FIG. 4 shows a simplified sequence diagram for elucidation of the dynamic adaptability of the system according to the invention.

### DETAILED DESCRIPTION OF THE INVENTION

The system comprises a server means SE, which is coupleabie to a number of client means CE via a communications network KN. The communications network KN may, for example, be a mobile network or the internet. However, with respect to the communications network KN, also a local network (LAN) can be involved. The server means SE is coupled to a storage means, which may comprise one or more data bases DB. The storage means may also be a component of the server means SE.

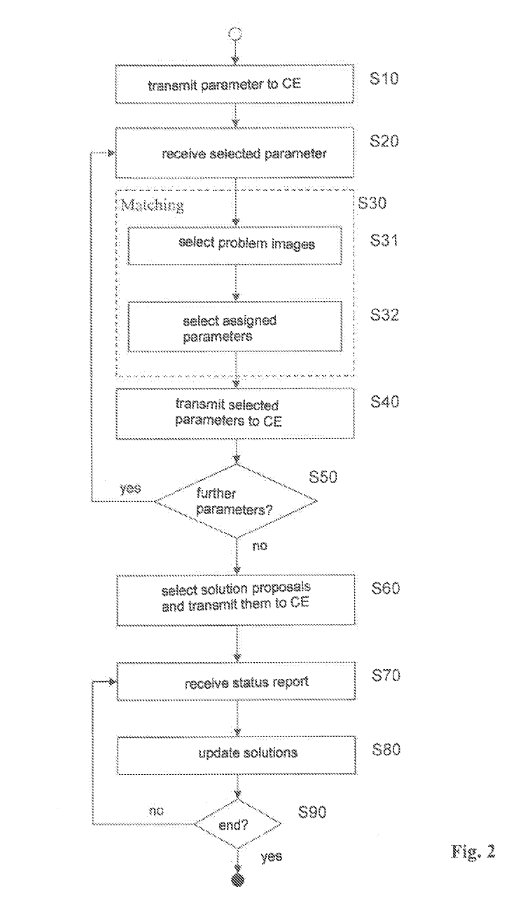

Further, the server means SE is coupled to a so called matching module M which is adapted to determine further parameters to be acquired or a number of possible solution proposals in addition to one or more acquired parameters, which may be provided to the client means CE. The matching module may be implemented by a further server means, or may be a component of the server means SE. The functioning of the matching module M is described in further detail with respect to FIG. 2 to FIG. 4.

In the storage means or in the data bases DB, a number of problem images, a number of parameters, and a number of solutions or solution proposals are stored, whereby at least one parameter and at least one solution or solution proposal are respectively assigned to the problem images. In the medical sector, a problem image may, for example, be a disease pattern, which is described by a number of symptoms (parameters).

In the medical sector, a solution or a solution proposal may be a therapy measure, which is provided for bringing the symptoms defining the disease pattern to a desired normal level.

Further, the storage means or the data bases DB are provided to store new problem images, parameters, and solutions or solution proposals, which can be derived by feedback through a user with respect to a certain problem image. For example, a user may document with respect to a certain problem image the change of the parameters describing the problem image over time, allowing for drawbacks with respect to the success of the solution proposal which has been applied.

In the medical sector, for example, a user may for a certain disease pattern and a certain therapy which has been applied provide a statement how the symptoms change during the therapy measure. In case for a certain disease pattern, several therapy measures are possible, from the respective changes of the symptoms, the quality of the therapy measure may be deduced compared to the other possible therapy measures.

Moreover, it is possible that the application of a. certain therapy measure leads to new symptoms occurring, which then also are stored as result of the therapy measure in the data base DB, Thereby, also new disease patterns not yet stored in the data base may evolve, which may then also be stored in the data bases DB. At the same time, also new therapies or therapy proposals with respect to the new disease patterns for which therapies are not yet stored in the data base may be automatically created, which are obtained from the user of the system providing statements of one or more applied therapy measures and the changes of the symptoms associated therewith over time. Thereby, basically a self-learning system is provided, which can automatically recognize new disease patterns and the possible therapies over time and store them in the storage means, as well as automatically optimize existing therapy measures automatically.

A very large number of client means may be coupled to the server means SE, such that, in turn, a very large number of users can acquire problem images and provide statements on the success of the solution proposals proposed for these. By this large number of users, on the one hand, it is possible to recognize outliers, for example, in case for a certain problem image, only very few users have provided a statement on a certain solution as being successful, while a very large number of users for the same problem image have stated another solution as being successful. On the other hand, due to the very large number of users it will become possible to determine, which solutions or solution proposals for which problem images have lead to which changes of the parameters most successfully. The solution proposals, for example, therapy proposals, determined for a certain problem image, for example, a disease pattern, will become more and more precise over time, because during determining the solution proposals, more and more information of users will be involved (so called swarm intelligence).

FIG. 2 shows a flow diagram of a method for acquiring problem images and for determining solution proposals according to the invention. The method according to the invention will be described in the following by means of an example from the medical sector. The method according to the invention may, however, also be applied to other problem domains. For example, the method according to the invention may be employed in order to provide a system for solving problems of automobiles or for solving problems in floriculture or in livestock farming. The method may also be employed for providing a system for solving problems in the field of mobile communications. For example, a mobile communications provider or a mobile communications supplier may implement the method according to the invention, according to which certain problem images can be acquired by indication of parameters and by means of which solution proposals can be determined for the problem images acquired, whereby the influences of the application of a solution on the parameters can be documented in order to draw conclusions to the success of the solution or in order to automatically generate new problem images or new solution proposals.

In a first step S10, the server means SE transmits a number of parameters to a client means CE. At the client means CE, the parameters transmitted are displayed on a display means for selection of a parameter by a user of the client means CE. The client means CE may be a common computer, a cellular phone, a tablet PC, a smart phone, or the like. In the medical sector, with respect to the parameters transmitted symptoms may be concerned, by means of which a disease pattern can be described or further specified.

The user may select a parameter from the number of transmitted parameters at the client means, whereby the selected parameter in the step S20 is transmitted to the server means SE und is received there. By transmitting possible parameters to be selected to the client means CE by the server means, it is avoided that a user of the system for describing the symptoms of a disease pattern has to perform textual input, which substantially improves the operability of the system. Thereby, it is further prevented that due to erroneous textural input, therapies are determined which are not suitable or wrong. A further advantage with the selection of parameters (the selection may, for example, be effected by so called check boxes) is that the parameters or the symptoms can be displayed in a language which is comprehensible for a non-professional person, because in this case the text of the parameter or the symptom does not have to be evaluated by the system according to the invention any further. Also, thereby the description of a problem image or a disease pattern may be effected substantially more efficient and expeditiously.

In the medical sector, parameters may be symptoms, for example, high blood pressure, very high blood pressure, a sore throat, fever, high fever, very high fever, or the like.

After the receipt of the selected parameter or the selected symptom in step S20, in a step S30, a so called matching is carried out on the server side, by means of which further parameters or symptoms are determined, which match the parameters received in step S20. For this, at first those problem images or disease patterns are selected in the step S31, which can be assigned to the parameters received in the step S20. Thereby, all of those disease patters or problem images can be excluded for the further processing, which do not contain this parameter.

In a further step S32, in addition to the problem images or disease patterns selected in step S31, those parameters or symptoms are determined which do not correspond to the parameters or symptoms transmitted in the step S20. This may, for example, result from simple subtraction.

The parameters or symptoms determined in the step S32 are transmitted to the client means CE in a further step S40, and there, they are displayed for selection by the user. Thereby, the possible parameters or symptoms to be selected are reduced on the user side, because only such symptoms are offered for selection, which in combination with the parameters already transmitted in the step S20 match a problem image or disease pattern.

The steps S20 to S40 may be repeated as long as in the step S32, no further parameters to be selected can be determined, or until the server means receives a termination signal from the client means.

In case in the step S40, further possible parameters have been transmitted to the client means CE, the method returns to the step S20, in which a further parameter to be selected by a user is received. In the second iteration, the server means SE has received two selected parameters from the client means CE, which are considered in the subsequent matching step S30. This leads to a further reduction of the number of possible further parameters to be selected in the second iteration. Thereby, the parameters to be transmitted in the step S40 are also reduced such that the number of the parameters displayed for selection at the client means with each iteration step preferably becomes smaller.

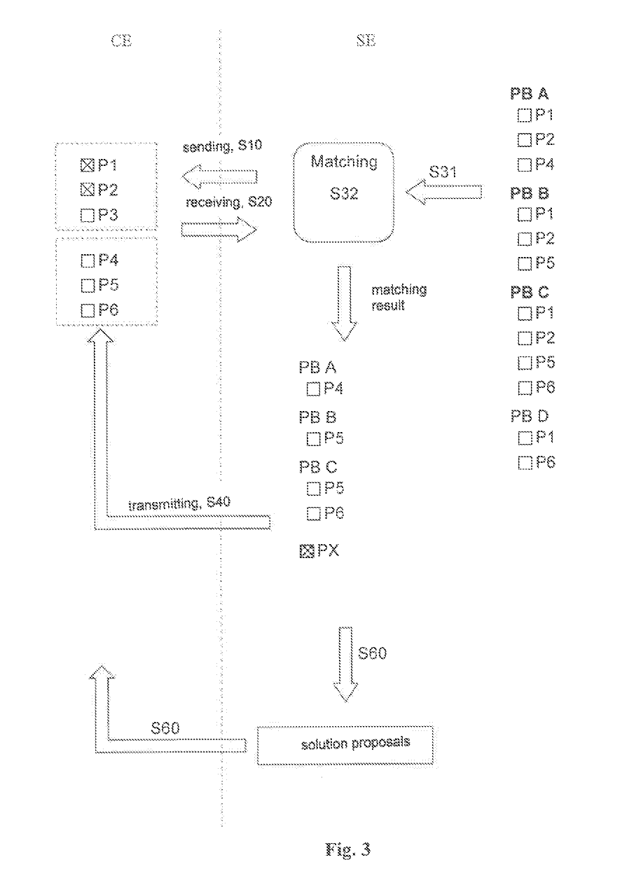

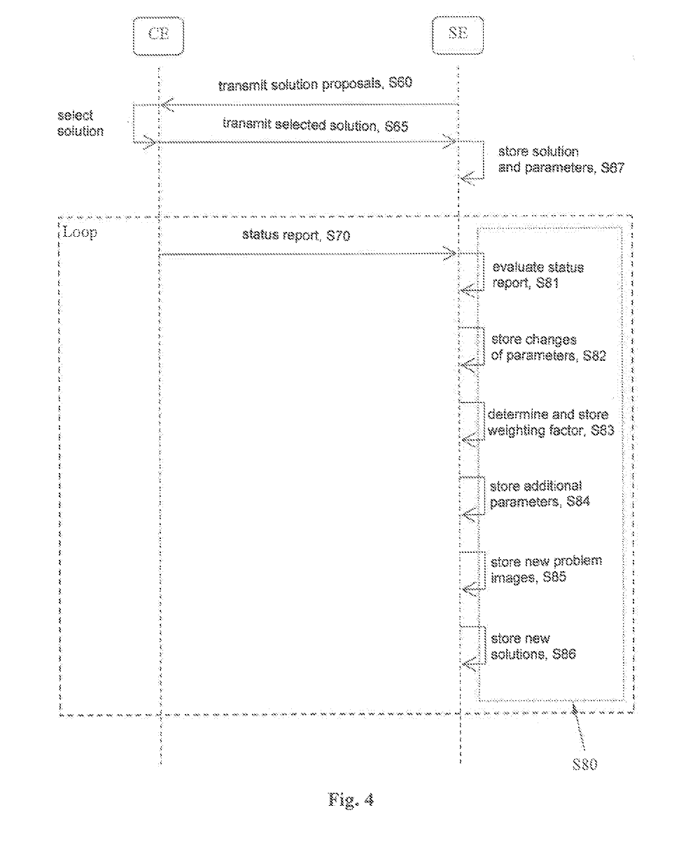

The system supports a user with the description or definition of a problem image or disease pattern by leading the user selectively by reduction of the possible parameters to a known disease pattern. The possibility of the input of parameters or symptoms which are not offered to the user for selection is further described with reference to FIG. 3 and FIG. 4.

After in the step S32, no further parameters for transmission to the client means can be selected any longer, or after the server means has received a termination signal from the client means, the server means, in the step S60, determines for the received parameters or for the disease patters matching to the received parameters, solution proposals or therapy proposals, and transmits these for selection by a user to the client means CE. In case several solution proposals or therapy proposals are determined by the server means, the user may select one of the possible therapy proposals at the client means CE.

The selection of a therapy proposal is transmitted to the server means, and there, it is stored together with a unique user identification in the storing means. For the authentication or authorization of a certain user, methods known from prior art can be used.

Because the selected therapy proposal is stored together with a unique user identification, the user is enabled to document the effects of the selected therapy on the progress of the disease or on the symptoms over time. For this, the user may, for example, input changes of the symptoms or parameters in predetermined temporal intervals into the client means CE. These changes are transmitted to the server means in a status report in the step S70, and are received there. By means of the received status report or by means of the changes in the parameters, the server means may perform an evaluation of the selected therapy, as is further described with reference to FIG. 4. Due to the evaluation, the selected solution or the selected therapy may be updated in a further step S80 such that for disease patterns acquired in the future, the updated therapy is available for the selection in the step S60.

In case the status report reveals that the parameters or symptoms have become worse, the selected therapy may be assigned to a negative evaluation factor. In case the evaluation of the status report reveals that the parameters or symptoms have been improved, the selected therapy may be assigned to a positive evaluation factor.

In case the system is used by a large number of users, statements concerning the success of a therapy are becoming more and more precise and specific, and can, moreover, be offered to the user for selection in a certain sequence. The swarm approach or the making use of the swarm intelligence of a large number of users, moreover, leads to outliers only having a very small or almost no influence on the general success prospects of a therapy for a certain disease pattern during the evaluation of a therapy by means of status notes, because these outliers are almost eliminated by the very large number of other evaluations.

The steps S70 and S80 may be repeated as long as all parameters of symptoms have levelled out at a desired normal level, and thereby, the therapy has been successful.

Alternatively, in a step S90 it can also be checked, whether a therapy is abandoned before the symptoms have levelled out at a normal level. The abandoning of a therapy, for example, may be initiated by a user at the client means CE. Alternatively, the abandoning of a therapy may also result in case, for example, no status report has been received over a longer time period. In an embodiment of the invention, in case of an abandoning of the therapy it may be provided for the status reports already received for this therapy being left unconsidered during the evaluation of the therapy.

On the basis of FIG. 3, the course of a method according to the invention is explained by means of a concrete example.

At first, in the step S10, the parameters P1, P2, and P3 are transmitted from the server means SE to the client means CE, and there, they are displayed in an appropriate manner to a user at a display means. The parameters P1 to P3 may, for example, be symptoms, by means of which a disease pattern may be further described or specified.

A user selects the parameters P1 and P2 at the client means CE. The selected parameters P1 and P2, in the step S20, are transmitted from the client means CE to the server means SE, and are received from the server means SE. The transmission of the selected parameters in the step S20 may be prompted automatically by the client means CE after each selection of a parameter by a user at the client means CE. Thus, for example, after selection of the parameter P1, only the parameter P1 is transmitted to the server means SE. After a further selection of the parameter P2, the parameter P1 as well as the parameter P2 is transmitted to the server means SE.

After receipt of one or more parameters at the server means SE, a so called matching is performed by the server means. For this, the server means SE selects in a step S31 a number of problem images. The problem images may be stored in a data base DB. In the example shown in FIG. 3, four problem images are stored in the data base DB, namely the problem images PB A, PB B, PB C, and PB D, which respectively are assigned to a number of parameters. For example, in problem image PB A, the parameters P1, P2, and P4 are assigned.

The selection in the step S31 is carried out such that only those problem images are selected from the number of problem images, which are assigned to the parameter transmitted in the step S20. In the example shown in FIG. 3, the problem images PB A, PB B, and PB C are accordingly selected, because these three problem images are respectively assigned to the parameters P1 and P2. The problem image PB D is not selected, because the parameter P2 is not assigned to the problem image PB D.

After selection of the relevant problem images, in a step S32 the parameters selected in a step S32 are processed, in order to be transmitted to the client means CE. The processing of the parameters may be such that from the parameters assigned to the selected parameters, those parameters are selected, which do not correspond to the parameters transmitted in the step S20. In the present case, this would be the parameter P4 for the problem image PB A, the parameter P5 for the problem image PB B, and the parameters P5 and P6 for the problem image PB C.

As can be seen in the example according to FIG. 4, the parameter P5 is assigned to two problem images, namely PB B and PB C. In order to avoid a multiple transmission of parameters, the result set of the parameters determined in the step S32 is reduced such that parameters, which occur multiply in the result set are only considered once. Of course, a reduction of the result set is only successful, if one or more parameters occur repeatedly in the result set. Alternatively, the reduction of the parameters may also be performed at the client means CE.

After the selection of the parameters in the step S32 and a possibly necessary reduction of the result set, the selected parameters are transmitted to the client means CE in the step S40, and there, they are displayed to a user for selection. In the present example, the parameters P4, P5, and P6 are transmitted to the client means CE accordingly. The user of the client means CE may select from the parameter (parameter P3) not yet selected in the first selection step, or from the newly transmitted parameters (parameters P4, P5, and P6) not transmitted in the last step, a further parameter, which then, in turn, is transmitted to the server means SE, whereby a repeated matching, as described previously, is initiated at the server means SE.

Of course, the user of a client means CE may also reverse the selection of an already transmitted parameter at the client means CE. This can, for example, be carried out by a deselection of a corresponding check box. After a deselection of an already transmitted parameter, in the step S20, the remaining selected parameters are transmitted to the server means SE, resulting in this case in the number of possible parameters to be selected possibly being increased again.

The steps S20, S31, S32, and S40 may be repeated as long as no further parameters are available for transmission in the step S40, or until the user terminates the selection of further parameters at the client means CE. In the latter case, the termination of the selection of further parameters is signalized to the server means SE.

After the selection has been terminated or no further parameters are available for selection, solution proposals for solution of problem images are determined by the server means SE in a step S60, and are transmitted to the client means CE. The selection of the solution proposals may result such that all solution proposals assigned to the possible problem images are selected, whereby those problem images are considered during the selection, which are assigned to the parameters received in the step S20. In case only the parameters P1 and P2 are transmitted to the server means SE in the example shown in FIG. 3, in the step S60, those solution proposals are selected, which are assigned to the problem images PB A, PB B, and PB C. If the parameter P4 would be transmitted to the server means in addition to the parameters P1 and P2, only those solution proposals would be selected, which are assigned to the problem image PB A.

The user may now select at the client means CE one of the possible solution proposals for the solution of the problem image. The selected solution proposal is transmitted to the server means SE, and there, it is stored together with a unique user identification. The further processing of the solution proposal transmitted to the server means as well as the processing of changes of the parameters over time due to the application of the solution proposal are further described with reference to FIG. 4.

In a further embodiment of the invention it may be provided for transmitting further parameters for selection by a user at the client means CE in addition to the parameters selected in the step S32. For example, a parameter PX may be transmitted to the client means CE, which is not assigned to the problem images selected in the step S31. The transmission of additional parameters may, for example, be requested by the user at the client means CE. For example, this is advantageous, if the user wants to further specify a problem image by means of a. further parameter, but this parameter, however, is not offered for selection. The selection of this further parameter PX then leads to a problem image, for example, a disease pattern, being described by the user, which is not yet known to the server means, because the set of the possible problem images does not comprise a problem image, to which the parameter PX is assigned. After the termination of the parameter selection by the user, the server means may generate a problem image and may store it in the storage means, whereby all parameters selected by the user are assigned to the new problem image. Thereby, basically a self-learning system is provided, which is adapted to generate new problem images with the associated parameters and to store it.

No solution proposals, at first, are assigned to such new problem images. In order to enable a simple assignment of solution proposals to such new problem images, the server means SE provides a number of possible solution proposals for selection to the user. The user may select from the number of solution proposals provided a solution proposal, which then is assigned to the new problem image in the data base.

The user may, however, also select partial solutions of several solution proposals, which then together form a new solution proposal, which is assigned to the new problem image.

The server-sided selection of possible solution proposals for a new problem image may, for example, be effected by selecting those solution proposals, which at least partially are assigned to the parameters transmitted to the server means SE.

Thereby, now a new problem image with the corresponding parameters and the corresponding therapy has been generated. This new problem image and the associated solution proposal now are available for a future acquisition of problem images and for a determination of solution proposals.

On the basis of a concrete example from the medical sector, in the following this behavior (self-learning ability of the system) is further explained.

A user has stomach pains and selects this symptom from 95 possible symptoms. The selection is transmitted to the server means SE. The system according to the invention then determines 243 different disease patterns, which may be assigned to the symptom stomach pains. To these 243 different disease patterns, altogether 45 further symptoms are assigned, which are transmitted to the client means CE for further selection. The number of possible symptoms to be selected at the client means, therefore, has been reduced to 46 symptoms altogether.

The user now realizes that he also has headaches. The symptom headache is comprised in the list of 45 further symptoms. The user selects the symptom headaches, which then is transmitted to the server means SE. The server means now determines the disease patterns, which are assigned to the symptoms stomach aches and headaches. Thereby, the number of the 243 different disease patterns is reduced to 78 disease patterns, and the number of the symptoms assigned to these disease patterns is reduced from 45 to 23 symptoms, which in turn are transmitted to the client means CE.

Now, the user recognizes that he also has pain in the limbs, and selects this symptom from the 23 further symptoms. The selection leads to the number of possible disease patters being reduced to 17 disease patterns with 5 further symptoms. These 5 symptoms are then transmitted for selection to the client means.

The user now further recognizes that he also has diarrhea. The symptom diarrhea, however, is not included in the list of the 5 still possible symptoms. In this case, the user may request the transmission of further symptoms, which are not assigned to the disease pattern selected by the server means. These further symptoms also comprise the symptom diarrhea. The user selects from these further symptoms the symptom diarrhea, which is then transmitted to the server means SE.

The system according to the invention, thereupon, creates a new disease pattern to which the symptoms stomach pains, headaches, pain in the limbs, and diarrhea are assigned, and stores the new disease pattern in the storage means. Because there a therapy or therapy proposal is not yet assigned to this new disease pattern, therapy proposals are provided to the user for selection, to which the named symptoms at least partly are assigned. For example, a therapy proposal for a disease pattern may be provided for selection, to which the symptoms stomach pains and headaches are assigned. Further, a further therapy proposal may be provided for selection, to which a disease pattern with the symptoms headaches and diarrhea are assigned. The user now may select one of the possible solution proposals or partial solutions from several solution proposals. The selected solution proposal or the selected partial solutions are transmitted to the server means, and are assigned to the new disease pattern as new solution proposal. Thereby, the system has learned something about a new disease pattern and about a new possible therapy proposal for this new disease pattern.

In order to determine whether the new therapy proposal with respect to the new disease pattern is a reasonable or successful therapy, the user is provided with the possibility to state to the system according to the invention changes of the symptoms stomach pains, headaches, pain in the limbs, and diarrhea over the time. Hereby, the system learns autonomously, which effects the therapy has with respect to the new disease pattern. If he therapy is successful, the symptoms will approach to a certain normal level or will level out to a predetermined normal level over the time, i.e., the symptoms will have disappeared. The therapy, thus, has been successful for the new disease pattern.

By storing the change of the symptoms over the time by application of the therapy approach for a certain disease pattern, the system according to the invention leans, which therapy approaches will lead to a desired change of the symptoms for which disease patterns. Also, the system according to the invention may learn which therapy approaches will lead to an undesirable change of the symptoms over the time or even to new symptoms (for example, side effects). An undesirable change of the symptoms or the occurrence of new symptoms may be taken into consideration during evaluation of a new therapy approach, as is described with reference to FIG. 4.

FIG. 4 shows a sequence diagram, according to which the creation of new problem images and the evaluation of solution proposals for already existing or for new problem images are further explained.

After the transmission of possible solution proposals in a step S60 from the server means SE to the client means CE, the user may select at the client means CE a solution proposal. The selected solution proposal is transmitted to the server means SE in a step S65. The parameters received in the step S20 (cf. FIG. 3 and FIG. 4) or the problem image to which the received parameters are assigned, are stored together with the selected solution proposal. Additionally, in the data set thus generated, a unique user identification is assigned in order to record the effects of the solution approach for the solution of the problem image over the time for this user.

After the problem Image or the parameters and the solution proposal for the user have been stored in the step S67, the user may transmit in regular or irregular intervals status reports to the server means SE in the step S70. The status report comprises information on whether and how the parameters change by the application of a selected solution proposal. For example, information on this may be transmitted to the server means SE with the status report that a symptom “very high fever” has changed and now has the value “low fever”.

In the step S81, the received status report is evaluated. The acquired changes of the parameters are stored in the step S82 for the disease pattern which is assigned to the unique user identification. From the change of the parameters, the system according to the invention may determine, how the selected solution proposal affects the problem image, and whether the application of the solution proposal leads to a solution of the problem image at all.

By means of this information, in a step S83, a weighting factor may be determined, and may be assigned to the solution proposal, whereby during determining the weighting factor, also weighting factors already assigned to the solution proposal may be considered. Thereby, for a large number of users, the possible solution proposals for certain problem images will become more and more precise and specific over the time such that during the course of time, for a certain problem image, always increasingly improved solution proposals can be offered.

In the step S70, also additional parameters may be transmitted to the server means by means of the status report, which, as described with reference to FIG. 3, are not assigned to any one of the selected problem images. These parameters may, for example, be new symptoms, which can occur during the application of a therapy, and which may be an indication for a side effect of the applied therapy.

An additional parameter can also be an expected parameter during the application of a therapy, if for a certain therapy during the application of the therapy a certain symptom is to be expected. For example, for a certain therapy approach it may be provided for the body temperature slightly rising at the beginning of the therapy. This would have the consequence that a new symptom “increased temperature” will be transmitted within the scope of the status report. This additional symptom then, however, will not be interpreted as side effect, but rather will have a positive influence on the weighting factor, because this symptom corresponds to the expected progress of the therapy measure. These parameters additionally transmitted may be stored for the problem image in the step S84.

An additionally transmitted parameter may also lead to new problem images arising, which also are stored in the step S85. For these new problem images, solution proposals may be generated automatically, and may be assigned to the new problem images, as is described, for example, with reference to FIG. 3. These new solutions are also stored in the step S86, and are assigned to the new problem images.

The system according to the invention or the method according to the invention are not limited to only already present of proposed therapies being allowed to be selected for a disease pattern. Within the scope of the self-learning mechanism, a user may also input a new therapy or a new therapy form for a disease pattern. The system stores this new therapy in the storage means and links it to the disease pattern of the user. In case this new therapy is successful for the user, it may also be proposed for the same disease pattern to other users as therapy proposal.

Also, the method according to the invention or the system according to the invention are adapted to receive new symptoms or parameters from a user and to store them, which previously have not yet been comprised in the set of symptoms. Thereby, the possibility is provided that a user generates or describes new disease patterns due to a certain combination of symptoms, which have not yet been known to the system previously. Thereby, the system may successively be augmented by new problem images or disease patterns. The possibility of the generation of new symptoms or parameters and the description of new disease patterns or problem images is especially advantageous, if in the system, a small set of parameters and problem images are stored, which, for example, may be the case, if the system has been set up for a new problem domain (e.g., rose breeding).

During the generation of new symptoms or parameters, it may be advantageous to provide a thesaurus in order to select similar parameters which already are present and to propose them to the user. Thereby, it is avoided that identical (with respect to the content) parameters are stored multiply. For example, the already present parameter “stomach pains” may be proposed to the user during input of the term “upset stomach”. Instead of the previously described selection of the parameters via, e.g., check boxes, the parameter input may also be effected via a text field according to an embodiment of the invention. Here, also when inputting the parameter by using a thesaurus, a comparison to already present parameters may result. In case the system finds similar parameters, it may suggest these for selection to the user.

In summary, a system is provided by the invention, which is self-learning and which is able to generate new problem images and associated solution proposals due to the inputs and experiences of a large number of users (swarm intelligence). The solution proposals already present for existing problem images, or newly generated solution proposals will also become more and more detailed and specific during the course of time due to the plurality of user inputs, which are transmitted, for example, within the scope of status reports to the server means, because during the selection of solution proposals for a certain problem image, the effects of the solution proposals on the problem image can be taken into consideration. Thereby, during the course of time, for certain problem images solution proposals emerge, according to which these can be solved in a particularly efficient manner.

Above, the application of the method according to the invention or the use of the system according to the invention has been described within the scope of a medical application. Of course, the method according to the invention or the system according to the invention may also be applied to other problem domains, for example, problems in the automotive sector, problems in the telecommunications sector, or the like.

1. A method for acquiring problem images and for determining solution proposals in a system comprising at least a server means and at least a client means, wherein the client means can be coupled to the server means via a communications network, wherein the server means is coupled to a storage means, in which a number of problem images, a number of parameters, and a number of solutions are stored, wherein at least a parameter and at least a solution are respectively assigned to the problem images, wherein the parameter assigned to the problem image describes the problem image, and wherein the server means
a) transmits a number of parameters to the client means for selection of at least one parameter by a user,
b) receives from the client means the at least one parameter selected by the user,
c) selects from the stored problem images those problem images, to which the received parameters are assigned, and selects from the parameters assigned to the selected problem images those parameters, which do not correspond to the already received parameters,
d) transmits the selected parameters for selection to the client means;
e) repeats the steps b) to d) as long as in the step c), no more parameters can be selected, or until the server means receives from the client means a termination signal,
f) determines the solutions assigned to the selected problem images, and transmits them as solution proposals to the client means for selection of a solution proposal by the user, and
g) receives from the client means a report, which comprises information on whether the application of the solution proposal selected by the user has been successful.

2. The method of claim 1, wherein the server means in a further step receives the solution proposal from the client means which has been selected by the user, stores the received solution proposal together with a user identification in the storage means, and assigns the parameters received in the step b) to the stored solution proposal.

3. The method of claim 1, wherein the server means receives from the client means at least one status report, which comprises information on whether and how the parameters received in the step b) change by the application of the applied solution proposal.

4. The method of claim 3, wherein the at least one status report is received in predetermined temporal intervals.

5. The method of claim 3, wherein the change of the parameters over the time is stored in the storage means, and is assigned to the selected solution proposal, and wherein based on the change of the parameters over the time, a weighting factor is determined for the selected solution proposal, and is assigned to the selected solution proposal, wherein during determining, the weighting factor, preferably a weighting factor already assigned to the selected solution proposal, is taken into consideration.

6. The method of claim 5, wherein for the solution proposals to be transmitted to the client means in the step f) a sequence is determined, which takes the weighting factors of the solution proposals into consideration.

7. The method of claim 1, wherein in addition to the parameters selected in the step c), further parameters are selected, which are not assigned to the selected problem images, and which are transmitted as optional parameters for selection to the client means, in particular, in a case, in which in the step c), no more parameters can be selected.

8. The method of claim 7, wherein the optional parameters are selected upon request by the client means and are transmitted.

9. The method of claim 7, wherein during a selection of an optional parameter by the user, a new problem image is stored in the storage means, and the received parameters are assigned to the new problem image.

10. The method of claim 9, wherein in the step f), solutions can be determined, according to which parameters are assigned to the corresponding problem images, which are at least partly comprised in the received parameters, and which are transmitted to the client means as solution proposals.

11. The method of claim 3; wherein the status report additionally comprises further information on whether further parameters have been added to the parameters already received, and wherein the further parameters are received by the server means.

12. The method of claim 11, wherein the further parameters are assigned to the new problem image.

13. The method of claim 11, wherein a new problem image is stored in the storage means, and at least one further parameter is assigned to the new problem image.

14. The method of claim 13, wherein the weighting factor assigned to the selected solution proposal is determined again and/or wherein information on the fact that further parameters have been added to the already received parameters affect the weighting factor to be determined again preferably in a negative manner.

15. A system for acquiring problem images and for determining solution proposals, wherein the system comprises at least one server means, which can be coupled to the client means via a communications network, wherein the server means is coupled to a storage means, in which a number of problem images, a number of parameters, and a number of solutions are stored, wherein at least a parameter and at least a solution are respectively assigned to the problem images, wherein the parameter assigned to the problem image describes the problem image, and wherein the system further comprises
a) means for selecting a number of parameters and for transmitting the parameters to the client means for selection of at least one parameter by a user,
b) means for receiving the at least one parameter selected by the user from the client means,
c) means for selecting problem images by means of the received parameters and for selecting parameters, which are assigned to the selected problem images,
d) means for selecting solution proposals, which are assigned to the selected problem images and for transmitting the selected solution proposals to the client means for selection of a solution proposal by the user of the client means.

16. The system of claim 15, wherein the server means and the means of the system are adapted for carrying out a method for acquiring problem images and for determining solution proposals wherein the server means
a) transmits a number of parameters to the client means for selection of at least one parameter by a user,
b) receives from the client means the at least one parameter selected by the user,
c) selects from the stored problem images those problems images, to which the received parameters are assigned, and selects from the parameters assigned to the selected problem images those parameters, which do not correspond to the already received parameters,
d) transmits the selected parameters for selection to the client means;
e) repeats the steps b) to d) as long as in the step c), no more parameters can be selected, or until the server means receives from the client means a termination signal,
f) determines the solutions assigned to the selected problems images, and transmits them as solution proposals to the client means for selection of a solution proposal by the user, and
g) receives from the client means a report, which comprises information on whether the application of the solution proposal selected by the user has been successful.

17. The method of claim 1, wherein the problem images comprise disease patterns, wherein the parameters comprise symptoms, by means of which the disease patterns can be described, and wherein the solution proposals comprise therapy proposals for treatment of at least one disease pattern.

18. A program means for a client means, in particular, data processing means or mobile terminal, which are adapted to
receive, from the system of claim 15, parameters, and display them on a display means for selection by a user,
transmit the selected parameters to the system, and
in response to the parameters transmitted to the system, receive further selected parameters or at least a solution proposal to be selected.

19. The program means of claim 18, wherein these are further adapted to request, in predetermined intervals or at predetermined time points, the user to acquire a change of the parameters and to transmit the acquired changes in a status report to the system.
